(19) United States
(12) Patent Application Publication
(10) Pub. No.: US 2007/0095934 A1
(43) Pub. Date: May 3, 2007

(54) Horizontal spool for direct needle closing

(75) Inventor: Ben Wisdom, Columbia, SC (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/582,102

(22) Filed: Oct. 17, 2006

Related U.S. Application Data
(60) Provisional application No. 60/727,935, filed on Oct. 18, 2005.

(51) Int. Cl. F02M 41/16

(52) U.S. Cl. 239/96; 239/88; 239/585.1

(57) ABSTRACT

A fuel injector assembly includes an intensifier piston and a spool valve that are movable along a first axis. The needle valve is controlled by a needle control valve that includes a spool that moves in a direction transverse to movement along the first axis.

### CROSS REFERENCE TO RELATED APPLICATION

The application claims priority to U.S. Provisional Application No. 60/727,935 which was filed on Oct. 18, 2005.

### BACKGROUND OF THE INVENTION

This invention generally relates to valve assembly for actuating a needle valve. More particularly, this invention relates to a spool valve actuateable for opening and closing a fuel injector needle valve.

A fuel injector for a vehicle provides for the selective injection of fuel into a combustion chamber. The fuel injector typically includes a needle valve that opens and closes to control the flow of fuel into the combustion chamber. Opening and closing of the fuel injector is timed with the combustion cycle of the engine and therefore speeds up or slows down depending on engine speed. The needle valve is desired to open and close quickly to facilitate properly timed injection of fuel.

A conventional fuel injector includes a spool valve movable parallel to the opening and closing movement of the needle valve. A solenoid device moves the spool valve within a valve body to control high pressure fluid flow to a top portion of the needle valve. The control of fluid flow by the spool valve provides a pressure imbalance that subsequently controls movement of the needle valve.

Disadvantageously, the parallel orientation of the spool valve requires complex fluid flow passages that are difficult and expensive to fabricate. Further, the parallel orientation and movement of the spool valve relative to the needle valve, and in some fuel injectors to an intensifier piston can detrimentally affect the opening and closing operation and time of the spool valve.

Accordingly, it is desirable to design and develop a valve for controlling the opening and closing of a needle valve that is less expensive to machine and less susceptible to operation of other valves within the fuel injector device.

### SUMMARY OF THE INVENTION

A needle valve assembly includes a direct needle control valve including a spool movable transverse to the direction of needle valve movement.

An example fuel injector includes an intensifier piston disposed within an intensifier valve body. The high pressure fuel is controlled by a needle valve. The needle valve moves between an opened and closed position along an axis common to the intensifier piston. A needle control valve includes a spool that moves in a direction transverse to movement the needle valve and the intensifier piston.

The spool valve moves transverse to the axial movement of the needle valve within a valve body. The valve body is disposed between the intensifier piston and needle valve. Movement of the spool within the valve body provides for the selective communication of high-pressure fuel to the top of the needle valve. The spool valve is also movable to communicate a low vent pressure to the top of the needle valve. The selective communication of fuel pressure to the top of the needle valve results in the balance or imbalance of fuel pressures on the needle valve. The differences in communication of fuel pressure provide for the opening and closing of the needle valve.

The direct needle control valve provides for the durable actuation of the needle valve without substantial interference caused by the axial movement of the intensifier and the needle valve during operation.

These and other features of the present invention can be best understood from the following specification and drawings, the following of which is a brief description.

### BRIEF DESCRIPTION OF THE DRAWINGS

FIG. 1 is a cross-sectional view of an example fuel injector assembly.

FIG. 2 is an enlarged cross-sectional view of an example direct needle control valve.

FIG. 3 is a sectional view of the example needle control valve.

### DETAILED DESCRIPTION OF THE PREFERRED EMBODIMENT

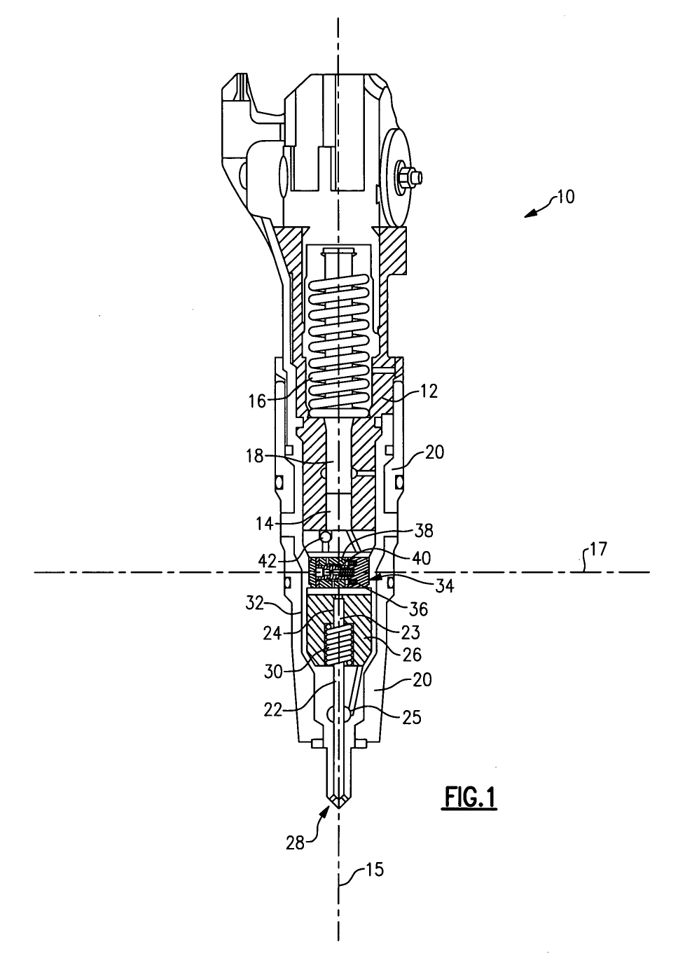

Referring to FIG. 1, an example fuel injector assembly 10 includes an intensifier body 12 that defines an intensifier bore 14 within which an intensifier piston 18 moves along a longitudinal axis 15. A sleeve 20 is attached to the intensifier body 12 and defines a high-pressure fuel passage 25 from the intensifier bore 14 to an outlet 28. The sleeve 20 also holds a needle valve body 26. The needle valve body 26 defines a needle valve bore 24 within which a needle valve 22 moves. The needle valve 22 moves between an open position that allows high-pressure fuel to exit the outlet 28, and a closed position where no fuel is allowed to exit the outlet 28.

Movement of the needle valve 22 is controlled by regulating a pressure differential about a head 23 of the needle valve 22. The needle valve is biased by a spring 30 towards the closed position. Fuel pressure on either side of the head 23 of the needle valve 22 provides for the selective opening and closing of the needle valve 22. The pressure at the above the head portion 23 of the needle valve 22 is controlled by the direct needle control valve 34.

The direct needle control valve 34 includes a spool valve 40. When the pressure above and below the head portion 23 is equal the bias force of the spring 30 provides a downward closing force on the needle valve 22. When the spool valve 40 is opened to vent, the fuel pressure above the spool valve head 23 is lower than the pressure below the spool valve head 23. This difference in pressure drives the spool valve 22 upwardly to an open position that allows fuel to exit the outlet 28.

Fuel pressure is communicated to the outlet 28 through the fuel passages 25 that go around both the direct needle control valve 34 and the needle valve body 26. This high pressure fuel is generated by action of the intensifier piston 18.

Both the intensifier piston 18 and the needle valve 22 move along the first longitudinal axis 15. This intensifier piston 18 movement along the first longitudinal axis 15 increases the fuel pressure. Movement of the needle valve 22 provides for the fuel flow.

Axial movement along the axis 15 can cause disruption that may affect operation of the direct needle control valve 34. However, the example direct needle control valve 34 includes the spool 40 that moves along an axis 17 that is transverse to the longitudinal axis 15. This transverse movement along the axis 17 substantially prevents movement along the longitudinal axis 15 from affecting control and actuation of the spool valve 40.

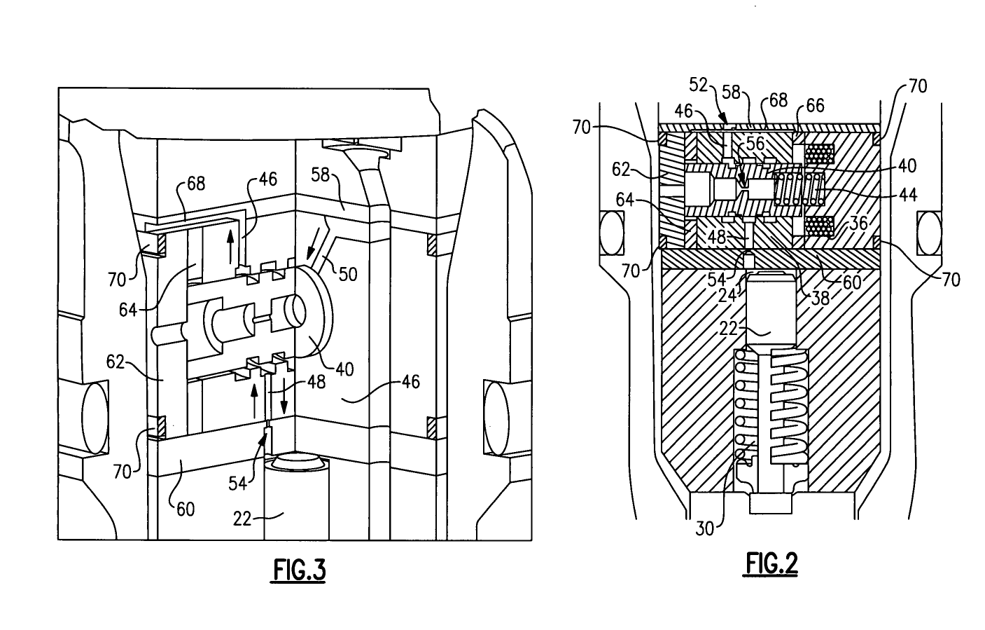

Referring to FIG. 2, the example direct needle control valve 34 includes the spool valve 40. The spool valve 40 moves along the axis 17 within a bore 41 defined by a valve body 38. The valve body 38 is disposed such that the bore 41 is transverse to the longitudinal axis 15. The spool valve 40 is biased towards a position allowing the communication of high-pressure fuel to the needle valve bore 24. This communication provides the desired pressure balance that results in the needle valve 22 being biased to the closed position. The spool valve 40 is biased in this position by a biasing spring 44.

Actuation of a solenoid 36 generates a magnetic force that acts on the spool valve 40 to move the spool valve 40 towards the solenoid 46 against the biasing force of the spring 44 to communicate a vent or low pressure with the top of the needle valve bore 24. The low pressure at the needle valve bore 24 creates the desired pressure imbalance that allows opening of the needle valve 22.

The valve body 38 includes an inlet 46 and an outlet 48. The fluid flows in two directions through the outlet 48. High pressure fuel flows into the bore 24 through this outlet 48. Also, when the spool valve 40 is in a position that provides for communication of vent to the bore 24, high pressure fluid will exit through this outlet 48.

The valve body 38 is sandwiched between a top inlet plate 58 and a bottom outlet plate 60. The top inlet plate 58 includes a throttle opening 52 that is sized to provide the desired fluid flow into the valve body bore. Similarly, the outlet plate 60 includes a throttle opening 54 that is sized to provide the desired fuel flow into the needle valve bore 24. Sizing of the throttle opening 52, 54 for both the inlet plate 58 and the outlet plate 60 are determined according to application specific requirements. The size of these throttle openings 52, 54 is determined to provide the desired fuel flow based on pressures to provide the desired opening and closing times of the needle valve 22.

The spool valves 40 includes a throttle passage 56. This throttle passage 56 is used to tailor opening and closing movement of the spool valve 40 within the valve body 38. This provides the desired actuation times of the needle valve 22.

The top inlet plate 58 includes a relief 68. The relief 68 provides and prevents a downward crushing force on the valve body 48 that may affect movement of the valve body 40. The direct needle control valve assembly 34 is sandwiched between the intensifier body 12 and the needle valve body 26. Accordingly, the relief 68 prevents any crushing force or other undesired forces on the valve body 34 that may affect free movement of the spool valve 40.

The control valve assembly 34 also includes an end plate 62. The end plate 62 is spaced apart from the valve body 38 by a first shim plate 64. This first shim plate 64 is used to tailor the stroke of the spool valve 40. In addition, a second shim plate 66 is disposed between the solenoid 36 and valve body 38. This second shim plate 66 is provided to tailor the air gap between the spool valve 40 and the solenoid 36. This air gap is tailored to provide the desired reaction times and movement of the spool valve 40 in response to actuation and energization of the solenoid 36.

The end plate 62 and the solenoid 36 are held against the valve body 38 by securement rings 70. The securement rings 70 encircle the valve assembly 34 at the top and bottom. The example securement rings 70 provide the clamping force required to maintain the desired air gaps between the end plate 62 and the solenoid 36. As the valve assembly 34 is disposed transversely, the compressive forces provided by the threaded interface between the sleeve 20 and body 12 cannot hold the valve assembly 34 together. The rings 70 hold the valve assembly together in the transverse direction. Further, the rings 70 secure the endplate 62 and solenoid 36 together in a subassembly to aid and simplify assembly.

The example securement rings 70 are fabricated from a metal banding material, however, any material that provides the desired clamping force, and that maintains the relative position of the valve assembly 34 components over the desired operation life is within the contemplation of this invention.

Referring to FIG. 3, another sectional view of the example control valve assembly 34 is illustrated and shows the vent passage 50. The vent passage 50 is disposed in a different plane than the inlet passage 46 and the outlet passage 48. The reason that the vent passage 50 is in a different plane is to reduce the possibility of leakage or any type of fluid communication between the vent 50 and the inlet 46. As appreciated, the recess 68 provided to prevent crushing forces on the valve body 38 also represents a fluid communication path therefore the vent 50 must be disposed in an orientation to prevent such undesired communication.

The horizontal orientation of the control valve assembly 34 eases manufacturing process time and expense. The example valve body 38 is greatly simplified as both the inlet 46 and outlet 48 can be machined in a single set up and is disposed within a common plane. No odd or irregular angles are required for these passages. Further, the vent passage 50 may also be fabricated in the same setup. Although the vent passage 50 is shown in an orientation different than those of the inlet 46 and outlet 48, the vent passage 50 maybe machined in such a manner to avoid the recess 68 and thereby provides the required function in a simplified manufacturing and assembly step.

Further, the spool valve 40 movement along the horizontal axis 17 substantially prevents any communication of movement or vibrations that may occur along the longitudinal axis 15 due to movement of the intensifier piston 18 and the spool valve 22.

Accordingly, the example spool valve assembly 34 for controlling the needle valve 22 according to this invention provides a durable, dependable and easily manufactured and assembled control valve to operate a needle valve. Further, the horizontal construction substantially eliminates effects that may be transmitted to effects and vibrations created by the intensifier piston 18 and spool valve 22 that could affect operation of digital valve assembly 34.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A fuel injector assembly comprising:
a needle valve movable between an open position allowing the flow of a fuel and a closed position preventing the flow of fuel; and
a spool valve controlling opening and closing of the needle valve, wherein the spool valve moves transverse to movement of the needle valve to selectively communicate pressure adjacent the needle valve to move the needle valve into one of the open and closed positions.

2. The assembly as recited in claim 1, wherein the spool valve is supported for transverse movement within a valve body, the valve body including a bore disposed along a spool valve axis transverse to movement of the needle valve.

3. The assembly as recited in claim 2, wherein the valve body includes an inlet in communication with a high pressure fuel passage, and outlet in communication with a chamber adjacent the needle valve and a vent.

4. The assembly as recited in claim 1 including an electromechanical device for generating a magnetic force to move the spool valve against a biasing member.

5. The assembly as recited in claim 4, wherein the electromechanical device includes a pole piece spaced apart from the valve body by a shim plate.

6. The assembly as recited in claim 3, including a first throttle plate including an inlet throttle aligned with the inlet in the valve body, and a second throttle plate including an outlet throttle aligned with the outlet of the valve body.

7. The assembly as recited in claim 6, wherein the first throttle plate includes a recess disposed adjacent the valve body.

8. The assembly as recited in claim 4, including a side plate spaced apart from an end of the valve body by a first shim plate.

9. The assembly as recited in claim 1, including an intensifier piston disposed within an intensifier chamber in communication with the inlet.

10. A fuel injector assembly comprising:
an intensifier piston movable within an intensifier along a first axis;
a needle valve disposed within a needle valve chamber and movable between an open position that allows the flow of fuel and a closed position preventing the flow of fuel, wherein said needle valve moves between the open position and the closed position along the first axis; and
a spool valve movable along a second axis transverse to the first axis, the spool valve controlling a pressure within the needle valve chamber for controlling movement of the needle valve along the first axis between the closed and open positions.

11. The assembly as recited in claim 10, wherein the first axis is disposed vertically and the second axis is disposed horizontally.

12. The assembly as recited in claim 10, including a biasing member biasing the spool valve toward a position communicating high-pressure fluid to the needle valve chamber such that the needle valve is biased toward the closed position.

13. The assembly as recited in claim 12, including a solenoid for generating a magnetic field to move the spool valve toward a position communicating a vent passage with the needle valve chamber.

14. The assembly as recited in claim 13, wherein the spool valve includes an internal passage comprising a throttle passage.

15. The assembly as recited in claim 10, wherein the spool valve is supported within a valve body including a transverse bore.
